(19) United States
(12) Patent Application Publication
(10) Pub. No.: US 2009/0141392 A1
(43) Pub. Date: Jun. 4, 2009

(54) MEASUREMENT METHOD OF MAGNETIC DISK APPARATUS, AND MAGNETIC DISK APPARATUS

(75) Inventor: Yukio URATA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/325,198

(22) Filed: Nov. 30, 2008

(30) Foreign Application Priority Data
Nov. 30, 2007 (JP) 2007-310745

(51) Int. Cl. G11B 5/596

(52) U.S. Cl. 360/77.05; G9B/5.216

(57) ABSTRACT

A gain controller changes a gain of a read amplifier depending on whether a head reads out servo data or user data. Further, a heater setting unit changes the temperature of a heater and a reading gain when detecting touchdown performed by the head. Accordingly, a dynamic range of AGC in a read-write channel is increased, so that error detection is prevented for touchdown that occurs because an AGC gain converged value remains at 0.

### BACKGROUND OF THE INVENTION

1. Field of the Invention

The present invention relates to a magnetic disk apparatus that changes the gain of a preamplifier depending on whether magnetic information read out by a head is servo data for positioning-use or user data stored in a user area available for reading and writing of given data, and a measurement method of the magnetic disk apparatus.

2. Description of the Related Art

A magnetic disk apparatus is used as one of auxiliary storage apparatuses of a computer. The magnetic disk apparatus includes a disk with a magnetic material applied, and stores therein data by magnetizing the disk.

The magnetic disk apparatus stores therein data that is broadly classified into two types: one is called servo data, and the other user data. The servo data is written in advance for a head position control performed by the magnetic disk apparatus. On the other hand, the user data is written to the disk by the magnetic disk apparatus upon receiving a write command from the computer. Related art is disclosed in, for example, Japanese Patent Application Laid-open No. 2005-302295.

To read out such data from the disk, the magnetic disk apparatus causes a reproducing head to generate a signal from a magnetic field generated on the disk. Since the generated signal is small, the magnetic disk apparatus inputs the signal to a preamplifier so as to amplify the input signal. Here, level of the amplification depends on a gain set to the preamplifier.

In general, the gain is set commonly, not individually, for a servo data signal and a user data signal. That is to say, the preamplifier amplifies signals of the two types with a commonly set gain. For example, the preamplifier amplifies an input signal corresponding to the servo data signal and amplifies an input signal corresponding to the user data signal, similarly by 10 times.

In recent years, recording density of user data in magnetic disk apparatuses has been increasing. As the recording density increases, interval of magnetic poles on a disk becomes a narrower in a horizontal recording system. Similarly, as the recording density increases, areas of the poles on the disk become smaller in a vertical recording system. Accordingly, the strength of the magnetic field generated by the magnetic poles becomes weak, so that the user data signal generated by the reproducing head becomes much smaller.

On the contrary, the recording density of the servo data remains still almost the same as it was before because information necessary for the magnetic disk apparatus to control the head position has not been remarkably changed from before. Thus, there is no need to make the magnetic poles to have a narrower interval or to make the poles to have smaller areas to increase the recording density of the servo data. In addition, the magnetic field generated by the magnetic poles has the same strength as it was before. As a result, the difference in signal intensity has been increased between the user data signal and the servo data signal.

Under such conditions, if the preamplifier amplifies the servo data signal and the user data signal with a commonly set gain as it was before, the user data signal cannot be processed in some circumstances. Hence, it causes a problem such that the magnetic disk apparatus cannot read out the user data.

Particularly, in a measurement in which an output of a data portion differs during measurement and in a measurement that is performed under the conditions with different output ranges from normal operations, such as a touchdown measurement that is performed by changing a heater setting of a head, reading and outputting of the data portion may deviate from a dynamic range. Accordingly, the measurement cannot be performed accurately.

Thus, it has been a significant challenge to increase the dynamic range by establishing a gain for reading and outputting of the data portion (a user data gain) independently from a gain for reading and outputting of the servo portion (a servo data gain), and by making the measurement possible with the user data gain being changed.

### SUMMARY

It is an object of the present invention to at least partially solve the problems in the conventional technology.

A measuring method of a magnetic disk apparatus according to one aspect of the present invention includes amplifying a user data with a user data gain, evaluating an output level of the amplified user data, changing the user data gain based on a result of the evaluating, amplifying the user data with the changed user data gain, and measuring a signal intensity of the user data. Here, the magnetic apparatus has a preamplifier amplifying servo data for positioning-use with a servo data gain and amplifying the user data stored in a user area available for reading and writing of given data with the user data gain.

A magnetic disk apparatus according to another aspect of the present invention has a preamplifier, an evaluating unit, and a measuring unit. The preamplifier amplifies servo data for positioning-use with a servo data gain and amplifies user data stored in a user area available for reading and writing of given data with a user data gain. The evaluating unit evaluates an output level of the user data amplified by the preamplifier with the user data gain. The measuring unit causes the preamplifier to change the user data gain and amplifies the user data with the changed user data gain based on the evaluation by the evaluating unit, so as to measure a signal intensity of the user data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an overview and a structure of a magnetic disk apparatus according to an embodiment of the present invention;

FIG. 2 is a table of exemplary information stored in a setting information storage unit;

FIG. 3 is a flowchart of processing operations performed by a gain controller;

FIG. 4 is a graph explaining touchdown detection with an AGC gain converged value;

FIG. 5 is a graph explaining touchdown detection with a changed gain of a preamplifier;

FIG. 6 is a flowchart of processing operations of the touchdown detection according to the embodiment; and

FIG. 7 is a table for explaining a specific setting example of the preamplifier.

### DETAILED DESCRIPTION OF THE PREFERRED EMBODIMENTS

Exemplary embodiments of a measurement method of a magnetic disk apparatus and a magnetic disk apparatus according to the present invention are described in detail with reference to the accompanying drawings.

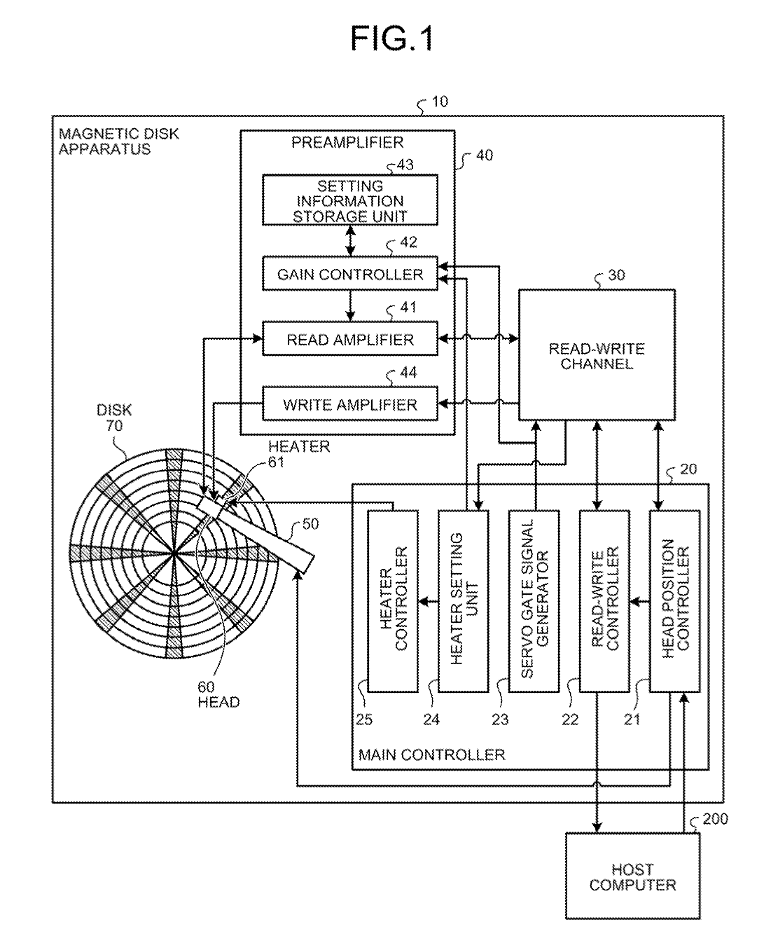

FIG. 1 is a diagram for explaining an overview and a structure of a magnetic disk apparatus according to an embodiment of the present invention. As shown in FIG. 1, a magnetic disk apparatus 10 includes a main controller 20, a read-write channel 30, a preamplifier 40, an actuator 50, a head 60, a heater 61, and a disk 70. The magnetic disk apparatus 10 is connected to a host computer 200 that serves as an auxiliary storage apparatus. In response to a data write command or a data read command from the host computer 200, the magnetic disk apparatus 10 stores or reproduces data accordingly.

Referring to FIG. 1, the following describes a servo gate signal along with an overview of the elements, specific operations performed by the preamplifier 40 receiving the servo gate signal, and finally operations performed by the main controller 20.

As shown in FIG. 1, the disk 70 is divided into a plurality of ring-shaped areas, each of which is called a track. In the disk 70, each of the tracks is further divided into predetermined areas, to which servo data and user data are written as magnetic information.

Specifically, in the disk 70, the servo data is written to areas indicated by hatched lines, and the user data is written to the other areas, as magnetic information. The servo data is magnetic information to be written to the disk 70 in advance to control the position of the head 60 by the magnetic disk apparatus 10. On the other hand, the user data is magnetic information that the magnetic disk apparatus 10 writes to the disk 70 in response to a write command received from the host computer 200.

The disk 70 is rotating at a predetermined rotational frequency during operation of the magnetic disk apparatus 10.

The head 60 is lifted up from a surface of the disk 70 with a certain space in between, and reads out magnetic information from the surface of the disk 70. Due to the rotation of the disk 70, the head 60 alternately faces servo areas to which the magnetic information being the servo data is written and data areas to which the magnetic information being the user data is written. Accordingly, the head 60 generates a servo data signal and a user data signal based on the magnetic information written to the respective areas, and outputs the signals to the preamplifier 40.

The preamplifier 40 amplifies each of the output signals from the head 60 with a predetermined gain, and outputs the signal to the read-write channel 30.

As described above, either the servo data signal or the user data signal is constantly input to the read-write channel 30 during operation of the magnetic disk apparatus 10.

In response to a command from the main controller 20, the read-write channel 30 performs various signal processes on the input signal from the preamplifier 40, and outputs the processed signal to the main controller 20.

When performing such signal processes, the read-write channel 30 needs to identify whether the signal received from the preamplifier 40 is a servo data signal or a user data signal, so as to only process the servo data signal and output to a processing result to the main controller 20 or to only process the user data signal to output a processing result to the main controller 20.

The servo gate signal is a signal that indicates whether the magnetic information read out by the head 60 is the servo data for positioning-use, or the user data stored in a user area available for reading and writing of given data. The servo gate signal is generated at a servo gate signal generator 23 in the main controller 20. Based on the servo gate signal, the read-write channel 30 processes an input signal from the preamplifier 40 individually, depending on whether the signal is the servo data signal or the user data signal.

The servo gate signal may be, for example, a signal having an output level that alternately changes between a first predetermined value and a second predetermined value at certain intervals. In this case, the read-write channel 30 determines a signal received from the preamplifier 40 to be the servo data signal when receiving a servo gate signal at the first predetermined value. On the contrary, if the output level is changed and the servo gate signal is received at the second predetermined value, the read-write channel 30 determines a signal received from the preamplifier 40 to be the user data signal.

Hereinbefore, the servo gate signal is explained. The following describes specific operations performed by the preamplifier 40 receiving the servo gate signal. In the magnetic disk apparatus 10 according to the embodiment of the present invention, the servo gate signal is input to the preamplifier 40, as well as to the read-write channel 30.

The preamplifier 40 amplifies an output from the head 60. The preamplifier 40 includes a setting information storage unit 43, a gain controller 42, a read amplifier 41, and a write amplifier 44. The servo gate signal is received at the gain controller 42.

The read amplifier 41 amplifies an output from the head 60 with a predetermined gain. The read amplifier 41 uses a variable gain.

The write amplifier 44 amplifies an output from the read-write channel 30 with a predetermined gain, and outputs the amplified signal to the head 60.

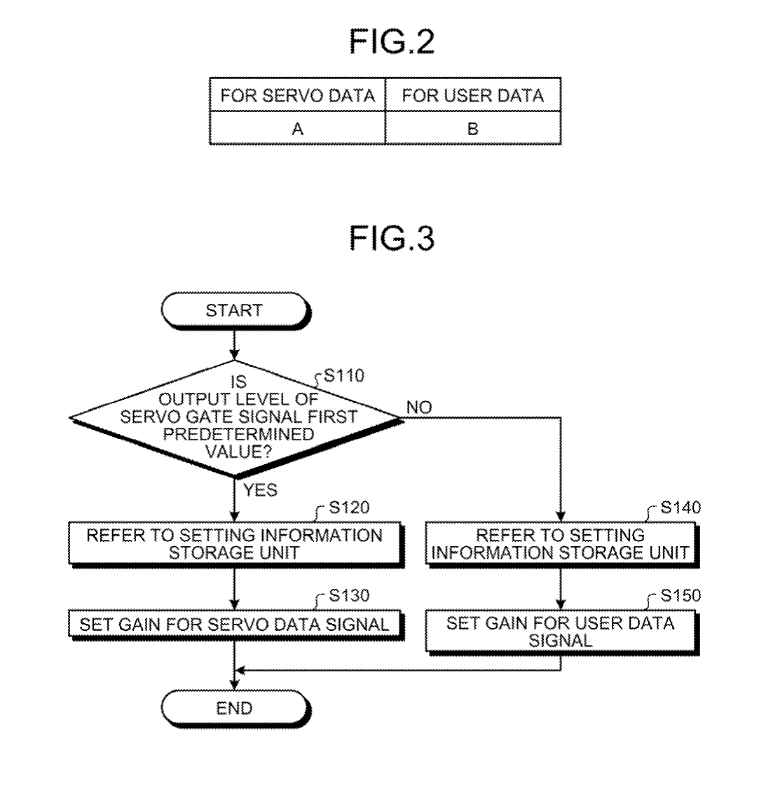

The setting information storage unit 43 stores therein a first gain for the servo data signal (a servo data gain), and a second gain for the user data signal (a user data gain). For example, as shown in FIG. 2, the setting information storage unit 43 stores therein a gain “A” for the servo data signal, and a gain “B” for the user data signal. FIG. 2 is a table of exemplary information stored in the setting information storage unit 43.

The gain controller 42 changes the gain of the read amplifier 41 based on the servo gate signal, depending on whether the magnetic information is the servo data or the user data.

For example, as to the servo gate signal having an output level that alternately changes between the first predetermined value and the second predetermined value at certain intervals, processing operations of the gain controller 42 are described with reference to a flowchart shown in FIG. 3.

FIG. 3 is a flowchart of processing operations performed by the gain controller 42. The process flow shown in FIG. 3 is repeatedly performed during operation performed by the magnetic disk apparatus 10.

If an output level of the received servo gate signal is the first predetermined value (YES at Step S110), the gain controller 42 determines that a signal being received from the head 60 is the servo data signal. The gain controller 42 then refers to the setting information storage unit 43 (Step S120), and sets the gain of the read amplifier 41 to the gain “A” for the servo data signal (Step S130).

On the contrary, if the output level of the received servo gate signal is the second predetermined value (NO at Step S110), the gain controller 42 determines that a signal being received from the head 60 is the user data signal. The gain controller 42 then refers to the setting information storage unit 43 (Step S140), and sets the gain of the read amplifier 41 to the gain “B” for the user data signal (Step S150).

Hereinbefore, the operations of the preamplifier 40 are explained. The following describes the main controller 20, and the processes for writing or reading of data performed by the magnetic disk apparatus 10 serving as an auxiliary storage apparatus of the host computer 200.

The main controller 20 performs overall control of the magnetic disk apparatus 10, and performs processes according to a data write command or a data read command received from the host computer 200. Specifically, the main controller 20 includes a head position controller 21, a read-write controller 22, the servo gate signal generator 23, a heater setting unit 24, and a heater controller 25. To provide a data read command, the host computer 200 sends to the magnetic disk apparatus 10 a read command and read position information. Here, the read position information indicates where on the disk 70 to read data. To provide a write command, the host computer 200 sends to the magnetic disk apparatus 10 a write command, write data, and write position information. Here, the write position information indicates where on the disk 70 to write the data.

The head position controller 21 moves the head 60 to a target track by controlling the actuator 50.

Specifically, the head position controller 21 receives the read command and the read position information sent from the host computer 200. The head position controller 21 then commands the read-write channel 30 to process the servo data signal and notify the current position of the head 60 on the disk. Accordingly, information on the current position on the disk is output from the read-write channel 30. The head position controller 21 controls the actuator 50 based on the information of the current position on the disk and the read position information, so as to move the head 60 to a target track. After positioning the head 60, the head position controller 21 outputs the read command and the read position information to the read-write controller 22.

On the contrary, when receiving the write command, the write data, and the write position information sent from the host computer 200, the head position controller 21 commands the read-write channel 30 to process the servo data signal and acquire the current position of the head 60 on the disk. Accordingly, information on the current position on the disk is output from the read-write channel 30. The head position controller 21 controls the actuator 50 based on the information on the current position on the disk and the write position information, so as to move the head 60 to a target track. After positioning the head 60, the head position controller 21 outputs the write command, the write data, and the write position information to the read-write controller 22.

The read-write controller 22 stores the write data sent from the host computer 200 in the disk 70. The read-write controller 22 also reproduces the data from the disk 70 and sends it to the host computer 200.

Specifically, upon receiving the read command and the read position information from the head position controller 21, the read-write controller 22 commands the read-write channel 30 to process the servo data signal and acquire the current position of the head 60 on the track. Accordingly, information on the current position on the track is output from the read-write channel 30. Based on the information on the current position on the track and the read position information, the read-write controller 22 commands the read-write channel 30 to process the user data signal and acquire user data. Accordingly, the user data is output from the read-write channel 30, and the read-write controller 22 sends the user data to the host computer 200.

On the contrary, upon receiving the write command, the write data, and the write position information from the head position controller 21, the read-write controller 22 commands the read-write channel 30 to process the servo data signal and acquire the current position of the head 60 on the track. Accordingly, information of the current position on the track is output from the read-write channel 30. The read-write controller 22 outputs the write data to the read-write channel 30 at predetermined timing based on the information on the current position on the track and the write position information.

As described above, the head position controller 21 and the read-write controller 22 provide various commands to the read-write channel 30. Then, the read-write channel 30 receives a servo data signal or a user data signal amplified by the preamplifier 40 with a gain individually set for each signal. Accordingly, even with a large voltage difference between the user data signal and the servo data signal, as long as appropriate gains have been set for respective signals of the two types, it can be avoided that the user data signal cannot be processed in the read-write channel 30 and the magnetic disk apparatus 10 cannot read out data.

The heater 61 adjusts a lift amount of the head 60 relative to the disk 70, by changing the temperature of the head 60. The heater 61 is controlled by the heater controller 25 in the main controller 20.

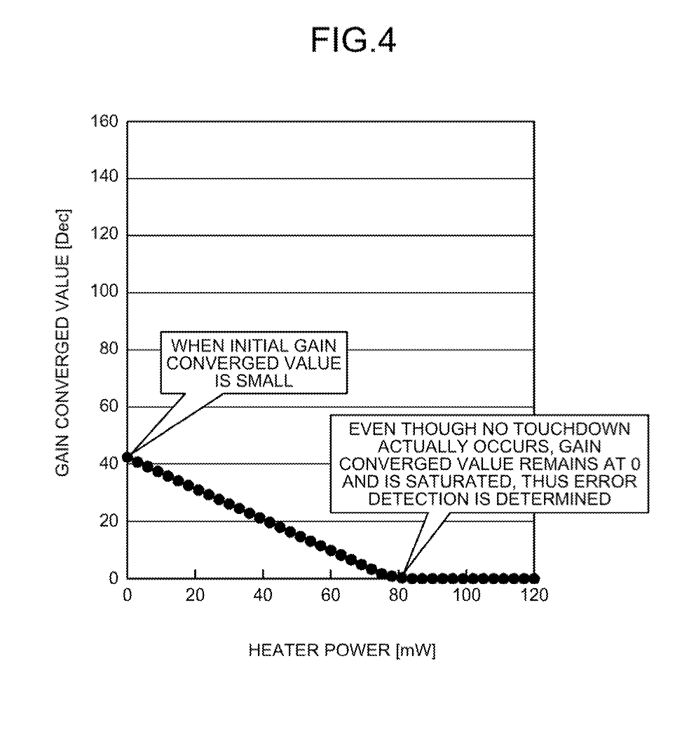

The heater setting unit 24 is a processor that measures the characteristics of the heater 61 to find an appropriate setting value for the heater 61. Specifically, the heater setting unit 24 measures a change in a converged value of the gain (hereinafter, “gain converged value”) of automatic gain control (AGC) in the read-write channel 30 while gradually increasing the temperature of the heater 61 as shown in FIG. 4. Accordingly, the heater setting unit 24 finds a saturation point of the gain converged value (a temperature at which the gain no longer decreases even when the temperature of the heater increases, i.e., a temperature at which the head 60 touches down the disk 70).

When the gain converged value remains at 0 during the measurement, however, the gain converged value cannot decrease any further even when no touchdown actually occurs. Thus, the gain converged value is saturated, so that error detection occurs.

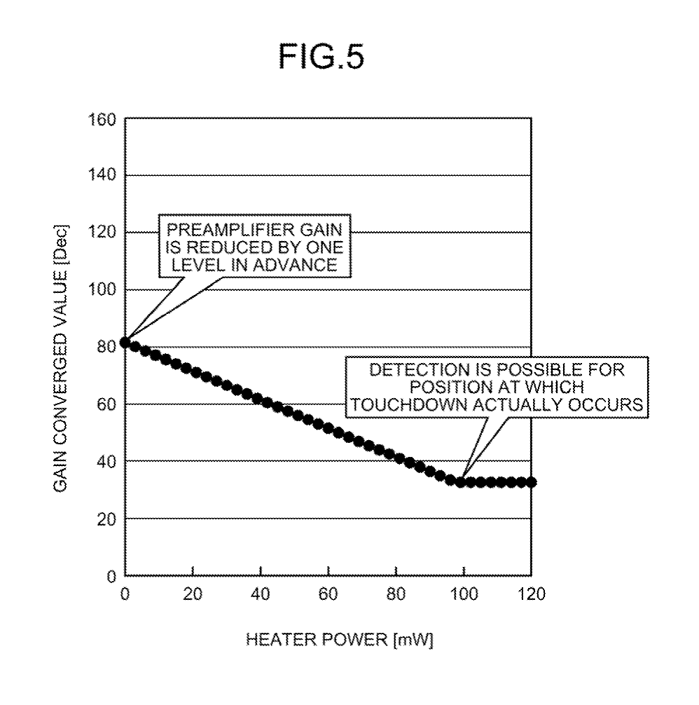

The heater setting unit 24 causes the gain controller 42 to change the user data gain, so that the gain of the preamplifier is reduced as shown in FIG. 5. In this way, the heater setting unit 24 performs control such that saturation of the gain converged value of the AGC due to the touchdown can be measured.

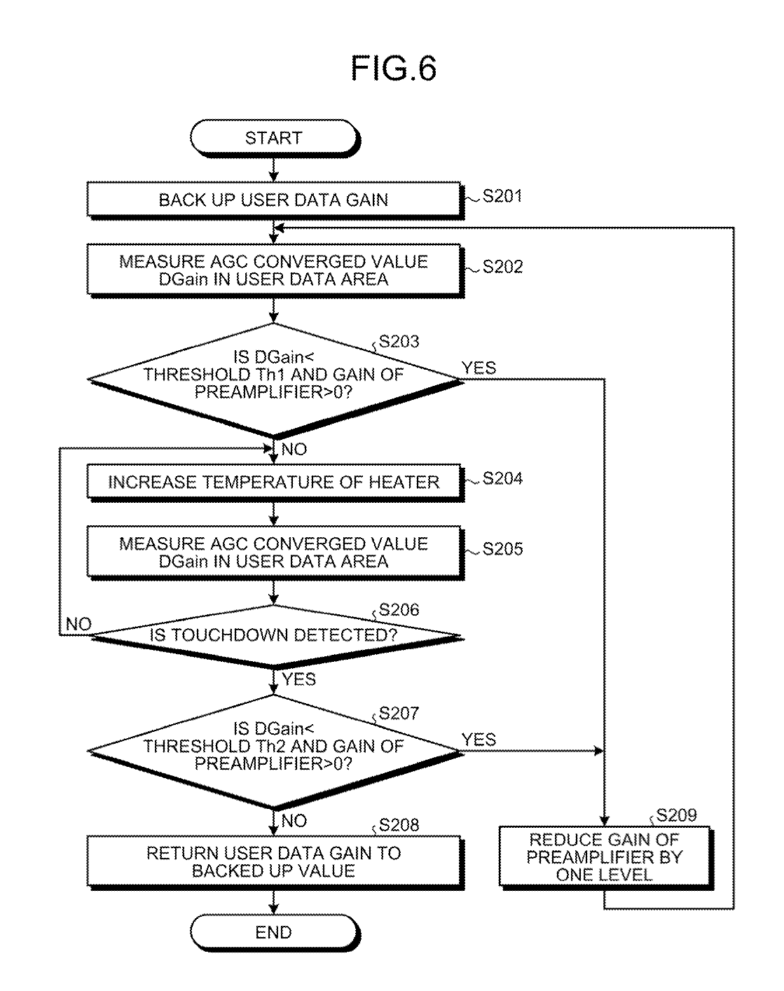

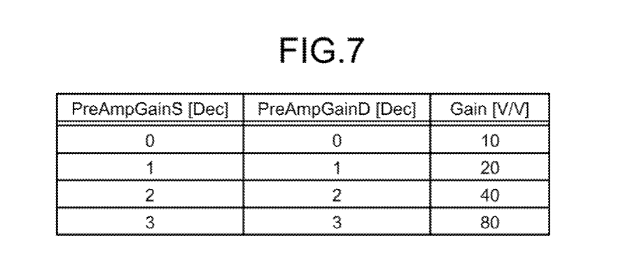

FIG. 6 is a flowchart of processing operations of touchdown measurement performed by the heater setting unit 24. FIG. 7 is a table of a specific setting example of the preamplifier used in the flow. In FIG. 7, the gain of the preamplifier includes four levels: 0 to 3, and the gain is 10 with “0” setting, 20 with “1” setting, 40 with “2” setting, and 80 with “3” setting. Such setting values of the preamplifier can be set individually for the servo data gain PreAmpGainS and the user data gain PreAmpGainD.

In FIG. 6, the heater setting unit 24 backs up the value of the user data gain that has been set appropriately for normal use (Step S201), and then measures an AGC converged value DGain in the user data area (Step S202).

The heater setting unit 24 determines whether the DGain is smaller than a threshold Th1 and the gain of the preamplifier is greater than 0 (Step S203). The threshold Th1 is for determining whether the AGC converged value is small and may possibly remain at 0 (whether the current setting value of the preamplifier is too large).

If the DGain is smaller than the threshold Th1 and the gain of the preamplifier is greater than 0 (YES at Step S203), the heater setting unit 24 reduces the gain of the preamplifier by one level (Step S209), and the system control goes back to Step S202.

On the contrary, if the DGain is equal to or larger than the threshold Th1 or the gain of the preamplifier is 0 (NO at Step S203), the heater setting unit 24 increases the temperature of the heater (Step S204), and measures the AGC converged value DGain in the user data area (Step S205).

The heater setting unit 24 detects occurrence of touchdown depending on whether the DGain is saturated due to the temperature change of the heater (Step S206). If no touchdown occurs (NO at Step S206), the system control goes back to the control for increasing the temperature of the heater (Step S204).

As a result, if the DGain is saturated (YES at Step S206), the heater setting unit 24 determines whether the DGain is smaller than a threshold Th2 and the gain of the preamplifier is greater than 0 (Step S207). The threshold Th2 is used to determine whether the saturation occurs because the AGC converged value remains at 0 (whether the detection of touchdown is error), and is desirably 1.

If the DGain is smaller than the threshold Th2 and the gain of the preamplifier is greater than 0 (YES at Step S207), the heater setting unit 24 reduces the gain of the preamplifier by one level (Step S209), and the system control goes back to Step S202.

On the contrary, if the DGain is equal to or greater than the threshold Th2 or the gain of the preamplifier is 0 (NO at Step S207), the heater setting unit 24 determines that the touchdown was properly detected, and sets the value of the user data gain to the backed up normal use value (Step S208), and terminates the process.

As described, the magnetic disk apparatus according to the present embodiment measures the signal intensity while changing the user data gain. Thus, a larger dynamic range can be obtained compared with an arrangement using a fixed gain. Hence, it becomes possible to accurately measure the characteristics of the heater, and to improve reading and writing capabilities of the disk apparatus, for example. During the measurement of the characteristics of the heater, the gain for the servo data is kept fixed so that the on-track accuracy is not degraded.

In the present embodiment, the foregoing describes the functions of the magnetic disk apparatus. It is also possible for an apparatus externally connected to a magnetic disk apparatus to implement the measurement method according to the embodiment of the present invention while controlling the user data gain.

The present invention can also be implemented as a computer program run by a magnetic disk apparatus itself or a apparatus externally connected to a magnetic disk apparatus.

According to an embodiment of the present invention, the apparatus and the method measure the signal intensity while changing the user data gain. Thus, a larger dynamic range can be obtained compared with an arrangement using a fixed gain. This brings about such advantages as accurately measuring the characteristics of the heater and improving reading and writing capabilities of the disk apparatus, for example.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A measuring method of a magnetic disk apparatus that has a preamplifier amplifying servo data for positioning-use with a servo data gain and amplifying user data stored in a user area available for reading and writing of given data with a user data gain, the measuring method comprising:
amplifying the user data with the user data gain;
evaluating an output level of the amplified user data;
changing the user data gain based on a result of the evaluating;
amplifying the user data with the changed user data gain; and
measuring a signal intensity of the user data.

2. The measuring method according to claim 1, further comprising:
changing a temperature of a head reading out at least one of the servo data and the user data so as to change a lift amount of the head from the magnetic disk surface, wherein
the measuring measures a change in the signal intensity due to a change in the temperature of the head.

3. A magnetic disk apparatus, comprising:
a preamplifier that amplifies servo data for positioning-use with a servo data gain and amplifies user data stored in a user area available for reading and writing of given data with a user data gain;
an evaluating unit that evaluates an output level of the user data amplified by the preamplifier with the user data gain; and
a measuring unit that causes the preamplifier to change the user data gain and amplify the user data with the changed user data gain based on the evaluation by the evaluating unit, so as to measure a signal intensity of the user data.

4. The magnetic disk apparatus according to claim 3, further comprising a head temperature controller that changes a temperature of a head reading out at least one of the servo data and the user data so as to change a lift amount of the head from the magnetic disk surface, wherein
the measuring unit measures a change in the signal intensity due to a change in the temperature of the head.
